(19) United States
(12) Patent Application Publication
(10) Pub. No.: US 2025/0086673 A1
(43) Pub. Date: Mar. 13, 2025

(54) Performance Optimization System and Method for a Client Advertising Campaign

(71) Applicant: LoopMe Limited, London (GB)

(72) Inventors: Yuliia Loktionova, London (GB); Stephen Upstone, London (GB); Marco Van de Bergh, Neunen (NL); Leonard Newnham, Calvert (GB)

(73) Assignee: LoopMe Ltd., London (GB)

(21) Appl. No.: 18/803,185

(22) Filed: Aug. 13, 2024

Related U.S. Application Data
(60) Provisional application No. 63/537,674, filed on Sep. 11, 2023.

(51) Int. Cl. G06Q 30/0242; G06Q 30/0251

(52) U.S. Cl. CPC G06Q 30/0244; G06Q 30/0246; G06Q 30/0257

(57) ABSTRACT

A performance optimization system (POS) includes: a POS data platform configured to store data usable to determine the POS score; a machine learning platform configured to use machine learning to determine the POS score, the machine learning platform operably connected to the POS data platform; a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement; and a prediction request log operably connected to the prediction server, the prediction request log configured to log the scored prediction request.

### PRIORITY CLAIM

The present application claims the priority benefit of U.S. provisional patent application No. 63/537,674 filed Sep. 11, 2023 and entitled “System and Method to Provide a Targeting Service for a Third-Party Advertising Campaign,” the disclosure of which is incorporated herein by reference.

### SUMMARY

Embodiments of this invention provide a system and method to provide a performance optimization service for a client advertising campaign.

Further embodiments of the invention comprise a performance optimization system (POS) data platform configured to store data usable to determine the POS score; a machine learning platform configured to use machine learning to determine the POS score, the machine learning platform operably connected to the POS data platform; a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement; and a prediction request log operably connected to the prediction server. The client comprises one or more of a paying client and an entity that receives the performance optimization service free of charge. The customer engagement platform comprises an end user system configured to run an advertising campaign, the end user system controllable by the performance optimization system.

The figures depict various embodiments for purposes of illustration only. One skilled in the art will readily recognize from the following discussion that alternative embodiments of the structure and methods illustrated herein may be employed without departing from the principles described herein.

A performance optimization system (POS) includes: a POS data platform configured to store data usable to determine the POS score; a machine learning platform configured to use machine learning to determine the POS score, the machine learning platform operably connected to the POS data platform; a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement; and a prediction request log operably connected to the prediction server, the prediction request log configured to log the scored prediction request.

A performance optimization system (POS) includes: a POS data platform configured to store data usable to determine the POS score; a machine learning platform configured to use machine learning to determine the POS score, the machine learning platform operably connected to the POS data platform; a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement; and a prediction request log operably connected to the prediction server, the prediction server further configured to create the prediction request by selecting relevant prediction request data from the advertisement request, the prediction request data comprising end user data, the prediction server then copying the relevant prediction request data to the prediction request, the prediction server sending the prediction request to the machine learning platform, wherein the machine learning platform comprises a model builder configured to build a predictive model usable to determine the POS score, the machine learning platform further comprising a model scorer operably connected to the model builder, the model scorer configured to receive the predictive model from the model builder, the model scorer further configured to use the predictive model to determine the POS score, wherein the POS score comprises an end user engagement metric predicting end user engagement with an advertisement, wherein the POS score further comprises one or more of a brand awareness score, a purchase intent score, a brand consideration score, and another metric configured to estimate awareness of an end user of an advertised brand, wherein the prediction server is further configured to add the POS score to the prediction request, creating a scored prediction request, wherein the prediction server is further configured to send the scored prediction request to the client DSP, wherein the prediction server is further configured to log the scored prediction request in the prediction request log, wherein the prediction request log is configured to log the scored prediction request, wherein the POS data platform comprises a profile store comprising a plurality of profiles of end users, the POS data platform further comprising a model store configured to store predictive models that the model builder builds, wherein the profile store comprises predictive end user data usable by the model builder to build the predictive model, wherein the performance optimization system is operably connected to a client demand-side platform (DSP), wherein the client DSP comprises an entity configured to do one or more of run an advertising campaign directly as an advertiser and run the advertising campaign on behalf of an advertiser, wherein the model scorer scores the prediction request without using the end user data, wherein the model scorer scores the prediction request without using personally identifiable information (PII) regarding the end user, wherein the prediction request comprises a request for a POS score from the client DSP to the prediction server, wherein the model builder builds the model using customer engagement data.

A customer engagement platform configured to gather customer engagement data regarding awareness by an end user of a brand, the customer engagement platform gathering customer engagement data by running an advertising campaign and recording whether the end user engages with the advertising campaign, the customer engagement platform including a performance optimization system (POS), an end user system configured to run an advertising campaign, the end user system operably connected to the performance optimization system, the performance optimization system comprising: a POS data platform configured to store data usable to determine the POS score; a machine learning platform configured to use machine learning to determine the POS score, the machine learning platform operably connected to the POS data platform; a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement; and a prediction request log operably connected to the prediction server, the prediction request log configured to log the scored prediction request, the end user system comprising: a control logic block operably connected to the end user, the control logic block configured to send a survey to the end user, the control logic block further configured to receive a survey response from the end user, the control logic bock further configured to send the survey response to the survey server, the control logic block further configured to log the survey response; a survey server operably connected to the control logic block, the survey server configured to obtain the survey from the survey store, the survey server further configured to send the survey to the control logic block, the survey server further configured to receive a survey response from the end user; an advertisement server operably connected to the control logic block, the advertisement server also operably connected to the survey server, the advertisement server configured to serve an advertisement to the end user; and an end user platform (EUP) comprising data needed by the end user system to run the advertising campaign, the EUP further comprising a survey store, the survey store comprising a survey configured to be sent to the end user to generate a survey response usable to measure effectiveness of the advertising campaign, the survey store logging the survey response that the control logic block logs, the EUP further comprising an advertisement store, the advertisement store comprising an advertisement usable in the advertising campaign.

A method for optimizing performance includes: receiving, by a performance optimization system (POS) comprising a POS data platform configured to store data usable to determine a POS score, the POS data platform comprising a profile store comprising a plurality of profiles of end users, the POS data platform further comprising a model store configured to store a predictive model usable to determine the POS score that the model builder builds, the performance optimization system further comprising a machine learning platform configured to use machine learning to determine the POS score, the machine learning platform operably connected to the POS data platform, the machine learning platform comprising a model builder configured to build the predictive model and a model scorer operably connected to the model builder, the model scorer configured to receive the predictive model from the model builder, the model scorer further configured to use the predictive model to determine the POS score, the performance optimization system further comprising a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement, the prediction server further configured to receive the prediction request from the client DSP, and a prediction request log operably connected to the prediction server, the prediction request log configured to log the scored prediction request, an advertisement request; selecting, by the performance optimization system, relevant prediction request data from the advertisement request; building, by the performance optimization system, using the model builder, the predictive model; determining, by the performance optimization system, using the model scorer, the model scorer using the predictive model, the POS score; creating, by the performance optimization system, the prediction request by copying the relevant prediction request data from the advertisement request to the prediction request; adding, by the performance optimization system, the POS score to the prediction request, creating a scored prediction request; and sending, by the performance optimization system, the POS score to the client DSP.

A method for optimizing performance includes: receiving, by a performance optimization system (POS) comprising a POS data platform configured to store data usable to determine a POS score, wherein the POS score comprises an end user engagement metric predicting end user engagement with an advertisement, wherein the POS score further comprises one or more of a brand awareness score, a purchase intent score, a brand consideration score, and another metric configured to estimate awareness of an end user of an advertised brand, the POS data platform comprising a profile store comprising a plurality of profiles of end users, the POS data platform further comprising a model store configured to store a predictive model usable to determine the POS score that the model builder builds, the performance optimization system further comprising a machine learning platform configured to use machine learning to determine the POS score, the machine learning platform operably connected to the POS data platform, the machine learning platform comprising a model builder configured to build the predictive model and a model scorer operably connected to the model builder, the model scorer configured to receive the predictive model from the model builder, the model scorer further configured to use the predictive model to determine the POS score, the performance optimization system further comprising a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement, the prediction server configured to receive the prediction request from a client demand-side platform (DSP), an advertisement request; selecting, by the performance optimization system, relevant prediction request data from the advertisement request, wherein the prediction request data comprises end user data; building, by the performance optimization system, using the model builder, the predictive model, wherein the building step comprises building the model using customer engagement data, the customer engagement data comprising survey responses, wherein the survey responses comprise end user profiles that comprise the end user's response to a customer engagement campaign; determining, by the performance optimization system, using the model scorer, the model scorer using the predictive model, the POS score, wherein the determining step further comprises determining the POS score without using end user data, wherein the determining step further comprises determining the POS score without using personally identifiable information (PII) regarding the end user, wherein the determining step comprises determining the POS score in real time, wherein the determining step comprises sub-steps of: creating a plurality of population groups, one population group comprising a control group comprising a baseline population group against which other population groups' POS scores can be compared, the plurality of population groups usable to determine the POS score for the prediction request; assigning the prediction request to a population group, wherein the assigning step comprises labeling a predetermined percentage of the prediction requests as control prediction requests belonging to the control group, wherein the assigning step further comprises randomly labeling the predetermined percentage of the prediction requests as control prediction requests, wherein the non-optimized POS score comprises one or more of a random POS score, a fixed POS score and a POS score that the prediction server chooses in any way without applying output from the model scorer, wherein the random POS score comprises a POS score that the prediction server randomly selects from a range of all possible POS scores, wherein the fixed POS score comprises a POS score equal to an average of POS scores the model scorer has determined for the treatment group over a selected time period; and determining the POS score for the prediction request based in part on the prediction request's population group; creating, by the performance optimization system, the prediction request by copying the relevant prediction request data from the advertisement request to the prediction request; adding, by the performance optimization system, the POS score to the prediction request, creating a scored prediction request; sending, by the performance optimization system, the POS score to the client DSP, wherein the profile store comprises predictive end user data usable by the model builder to build the predictive model; determining, by the performance optimization system, using the model scorer, the model scorer using the predictive model, the POS score for the treatment group prediction request; assigning, by the performance optimization system, for the control group prediction request, a non-optimized POS score to the control group prediction request, the non-optimized POS score usable to determine the performance of the treatment group, wherein the prediction request comprises a request for a POS score from the client DSP to the prediction server, wherein the performance optimization system further comprises a prediction request log operably connected to the prediction server; and logging, by the performance optimization system, in the prediction request log, the scored prediction request, wherein the assigning step comprises assigning a predetermined fraction of prediction requests to the control group, wherein the assigning step further comprises assigning prediction requests not belonging to the control group to a treatment group.

### BRIEF DESCRIPTION OF THE FIGURES

FIG. 1 is a drawing of a performance optimization system configured to provide a performance optimization service for a client advertising service.

FIG. 2 is a drawing of an environment comprising the customer engagement platform, an end user, a client demand-side platform (DSP), and an advertiser.

FIG. 3 is a drawing of an environment in which a customer engagement platform provides a performance measurement service for a client DSP.

FIG. 4 is a flow chart of a method for optimizing performance using a performance optimization system (POS).

FIG. 5 is a flow chart of a more detailed method for optimizing performance using a performance optimization system (POS).

FIGS. 6A-6B show the typical placing of a winning advertisement in a reserved advertising space on an end user device controlled by an end user, and an example of a survey that may be displayed in the reserved advertising space.

### DETAILED DESCRIPTION

A customer engagement platform comprises one or more of a performance optimization system (POS) and an end user system configured to run an advertising campaign. Preferably, but not necessarily, the customer engagement platform comprises both the performance optimization system and the end user system. The customer engagement platform is configured to do one or more of gather customer engagement data regarding awareness by an end user of a brand, build a predictive model using the customer engagement data, generate a performance optimization system (POS) score, the POS score comprising an end user engagement metric predicting end user engagement with an advertisement, and transmit the POS score to the end user. Preferably, but not necessarily, the customer engagement platform is configured to gather the customer engagement data, to build the predictive model using the customer engagement data, to generate the POS score, and to transmit the POS score to the end user. The customer engagement platform comprises a computer system. Preferably, but not necessarily, the customer engagement platform comprises one or more of a server and a database. Preferably, but not necessarily, the customer engagement platform comprises both a server and a database. Most preferably, but not necessarily, the customer engagement platform comprises a plurality of servers and further comprises a plurality of databases.

The end user system is configured to run an advertising campaign. The advertising campaign comprises one or more of an online advertising campaign, an offline advertising campaign, a digital advertising campaign and another type of advertising campaign. The performance optimization system is configured to provide to the client DSP a POS score comprising an end user engagement metric predicting end user engagement with an advertisement. Preferably, but not necessarily, the performance optimization system is configured to provide to the client DSP the POS score comprising an end user engagement metric predicting end user engagement with an advertisement. The client DSP comprises an entity doing one or more of running an advertising campaign directly as an advertiser and running the advertising campaign on behalf of an advertiser.

The POS score comprises one or more of a brand awareness score, a purchase intent score, a brand consideration score, and any other metric configured to estimate awareness of an end user of an advertised brand.

The performance optimization system comprises a POS data platform configured to store data usable to determine the POS score, a machine learning platform configured to use machine learning to determine the POS score, the machine learning platform operably connected to the POS data platform, a prediction server operably connected to the machine learning platform, the prediction server comprising a server configured to receive a prediction request from the client DSP, and a prediction request log operably connected to the prediction server. Preferably, but not necessarily, the prediction server is further configured to send the prediction request to the machine learning platform. Preferably, but not necessarily, the prediction server is further configured to receive a scored prediction request from the machine learning platform. Preferably, but not necessarily, the prediction server is further configured to log the scored prediction request. The prediction request log is configured to log the scored prediction request.

Preferably, but not necessarily, the machine learning platform comprises one or more of a model builder configured to build a predictive model usable to determine the POS score and a model scorer operably connected to the model builder, the model scorer configured to receive the predictive model from the model builder, the model scorer further configured to determine the POS score using the predictive model. Most preferably, but not necessarily, the machine learning platform comprises both the model builder and the model scorer. Preferably, but not necessarily, the POS data platform comprises one or more of a profile store comprising a plurality of profiles of end users, and a model store configured to store predictive models that the model builder builds. Most preferably, but not necessarily, the POS data platform comprises both the profile store and the model store. The client DSP may request a POS score by sending a prediction request to the prediction server. Preferably, but not necessarily, the profile store comprises predictive end user data usable by the performance optimization system to build a predictive model.

In an alternative configuration, the client DSP need not send the prediction requests to the customer engagement platform. According to these embodiments, the customer engagement platform receives an advertisement request directly from a supply-side platform (SSP). The SSP comprises a technology platform that enables publishers to manage and sell their digital advertising inventory programmatically. For example, a system operator configures the customer engagement platform to receive advertisement requests sent by the SSP.

When the performance optimization system receives the advertisement request, the performance optimization system creates a prediction request from the advertisement request. The performance optimization system, using the prediction server, creates the prediction request by selecting relevant prediction request data from the advertisement request, then copying the relevant prediction request data to the prediction request. The performance optimization system scores the prediction request using the model scorer. After the model scorer determines the POS score, as described below in more detail, the performance optimization system adds the POS score to the advertisement request, creating a scored prediction request, and sends this scored advertisement request to the client DSP. The client DSP then can filter the advertisement request using the POS score provided by the performance optimization system.

The prediction request comprises prediction request data. The prediction request data comprises end user data. The end user data comprises one or more of end user personal data, end user device data, contextual data, advertisement spot data, website data, mobile app data, network data, and privacy data.

The end user personal data comprises one or more of demographic data, location data, and behavioral data. The demographic data comprises one or more of an end user age, an end user gender, an end user income level, an end user education, and the like. The location data comprises one or more of an end user Global Position System (GPS) coordinate, an end user Internet Protocol (IP) address, an end user country, an end user city, and an end user postal code. The behavioral data comprises one or more of an end user browsing history, an end user search query, an end user purchase history, and other end user behavioral data.

The end user device data comprises one or more of an end user device type, an end user device operating system, end user device browser information, an end user device identifier, and an end user device screen resolution. The end user device type comprises one or more of mobile, desktop, tablet, and another end user device type. The end user device operating system comprises one or more of iPhone Operating System (IOS), Android, Windows, Mac Operating System (macOS), and another end user device operating system. The end user device browser information comprises one or more of a type of browser that the end user is using and a version of the browser that the end user is using. The end user device identifier comprises one or more of an Identifier for Advertisers (IDFA) device identifier, a Google Advertising Identifier (GAID) device identifier, and another end user device identifier. The end user device screen resolution comprises one or more of an end user device screen dimension and an end user device screen pixel density.

The contextual data comprises one or more of a Uniform Resource Locator (URL) of a webpage where the advertisement is to be displayed, page content data, and advertisement placement data. The page content data comprises one or more of a content keyword, a content category, and the like. The advertisement placement data comprises one or more of a position of the advertisement and a size of the advertisement.

The advertisement spot data comprises one or more of an advertisement spot dimension, an advertisement spot unique identifier, an advertisement spot format, and advertisement spot visibility data. The advertisement spot format comprises one or more of a banner, a video, a native advertisement, and another advertisement spot format. The advertisement spot visibility data comprises one or more of an advertisement visibility metric and an advertisement visibility prediction.

The website data comprises one or more of a website identifier, a category of a website, and website information. The mobile app data comprises one or more of a mobile app identifier, a category of a mobile app, and app information. The site information comprises one or more of a name of the site and a description of the site. The app information comprises one or more of a name of the app and a description of the app.

The network data comprises one or more of an Internet Protocol (IP) address, a connection type, and Internet Service Provider (ISP) data. The connection type comprises one or more of a Wireless Fidelity (Wi-Fi) connection, a cellular data connection, a wired connection, and another connection type. The ISP data comprises one or more of an ISP name, an ISP location, and other ISP data.

The privacy data comprises one or more of a consent string and an opt-out flag. The consent string comprises information about user content. For example, the consent string comprises General Data Protection Regulation (GDPR) compliance data. For example, the consent string is usable for one or more of data collection and advertisement targeting. The opt-out flag comprises an indicator that the end user has opted out of a data collection practice. The performance optimization system, using the model builder, builds the predictive model usable to determine the POS score, the model scorer receives the predictive model from the model builder, and the model scorer uses the predictive model to determine the POS score by scoring the predictive model that the model builder built. Scoring the predictive model comprises generating a POS score using input end user data from the prediction request.

The end user system comprises an end user platform. The end user platform comprises data needed by the end user system to run the advertising campaign. Preferably, but not necessarily, the end user platform comprises a survey store, the survey store in turn comprising one or more surveys configured to be sent to the end user to generate a survey response usable to measure effectiveness of the advertising campaign. Preferably, but not necessarily, the end user platform further comprises an advertisement store, the advertisement store in turn comprising one or more advertisements usable in the advertising campaign. Most preferably, but not necessarily, the end user platform comprises both the survey store and the advertisement store. Preferably, but not necessarily, the end user system is configured to run a brand advertising campaign, where brand advertising campaigns are run concurrently with an online survey. The online surveys collect data from a plurality of end users interacting with a plurality of campaigns. The performance optimization system builds a predictive model configured to estimate generic customer engagement using a survey response by an end user. Preferably, but not necessarily, the performance optimization system builds a predictive model configured to estimate the generic customer engagement using a plurality of survey responses, each survey response being prepared by an end user. The performance optimization system attaches the completed survey response to a profile for the end user. A profile comprises a known end user attribute of the end user. Preferably, but not necessarily, the profile comprises a plurality of the known end user attributes. The end user attribute comprises one of more of behavioral end user data, demographic end user data, and other end user data. For example, the behavioral end user data comprises one or more of a web page viewed, time spent on a page, a mobile application used, click-through history, and the like. The other end user data comprises one or more of end user age, end user income, end user place of residence, end user device data regarding the end user device, and the like. Preferably, although not necessarily, the performance optimization system builds a predictive model configured to estimate generic customer engagement for a plurality of survey responses in a plurality of advertising campaigns. Alternatively, or additionally, the performance optimization system builds the generic predictive model directly using one or more of customer purchase data, browsing history data, and any other outcome of interest to one or more of a client DSP and an advertiser. Embodiments of the invention are designed so that only a relatively small number of survey responses are needed with the consent of the end user to build a predictive model that can then be used to target all end users, whether those end users provide their consent or not. For example, embodiments of the invention can effectively target advertisements to end users when a number of end users providing consent is as low as ten percent (10%).

An advertisement request comprises end user data regarding one or more of the end user, the end user device, and other information. The end user device comprises an advertisement spot configured to display an advertisement to the end user. The advertisement spot comprises one or more of an area reserved for an advertisement within a webpage displayed by the end user device and a portion of an application of the end user device that is reserved for an advertisement. The advertisement spot comprises one or more of a webpage and a mobile application, the advertisement spot comprising a space reserved to display an advertisement.

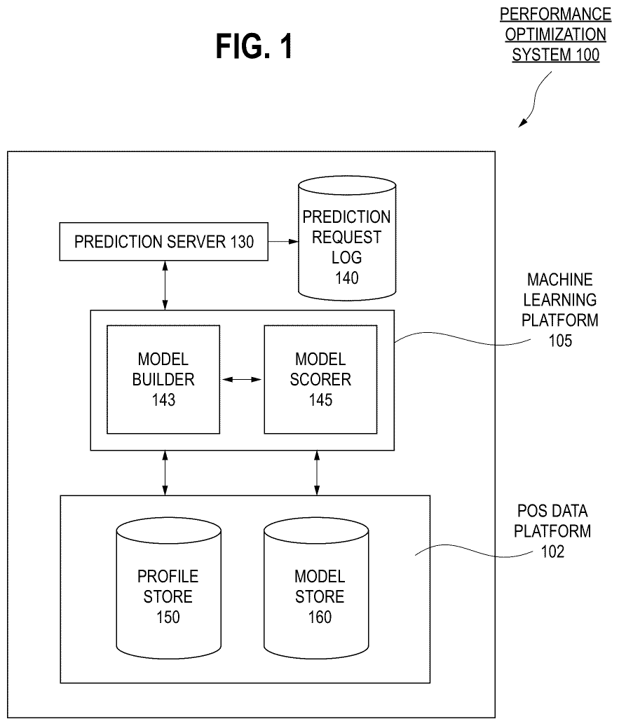

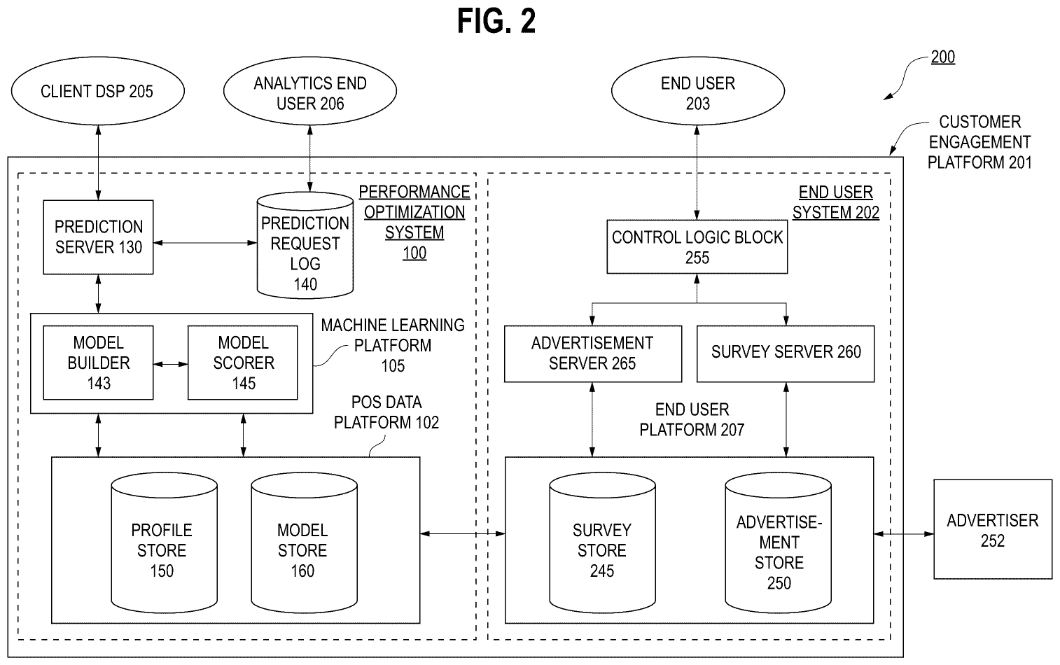

When the end user views an end user device where there is a space reserved for an advertisement, and therefore the end user device comprises the advertisement spot, the end user device sends an advertisement request to an SSP. The SSP sends the request to one or more DSPs. Embodiments of the invention provide a service to client DSPs to score individual prediction requests with a POS score. Preferably, but not necessarily, the client DSP sends a prediction request to the prediction server. The prediction server scores the prediction request with the POS score in real time. The model scorer determines the POS score using the prediction request data received in the prediction request. Alternatively, or additionally, the customer engagement platform listens for advertisement requests that are sent directly from the SSP. When the prediction server receives an advertisement request while an end user system (not shown in FIG. 1; item 202 in FIG. 2) is running an advertising campaign for an advertiser, the prediction server scores the individual prediction request with the POS score and adds this POS score to the prediction request. Preferably, but not necessarily, the prediction server scores the prediction request in real time, creating a scored prediction request. The prediction server then sends the scored prediction request to the client DSP. The prediction request data comprises end user data regarding the end user. Typically, the end user data comprises both personally identifiable information (PII) usable to identify the end user and publicly available information. PII comprises one or more of an end user identifier, an end user location, an end user Internet Protocol (IP) address, an end user telephone number, an end user email address, an end user name, an end user social media handle, and other end user-specific end user data.

Preferably, but not necessarily, the performance optimization system scores the prediction request without using PII regarding the end user. Alternatively, or additionally, the performance optimization system scores the prediction request without requiring PII. Preferably, but not necessarily, the performance optimization system scores the prediction request without using end user information. Alternatively, or additionally, the performance optimization system scores the prediction request without requiring the end user information.

The system's ability to operate without requiring PII facilitates performing targeted advertising in geographies with the highest end user privacy standards. The system does not require personal identifiers to operate, which is important for countries with strict privacy standards. Thus, embodiments of the invention score the prediction request without using the PII. Alternatively, or additionally, embodiments of the invention score the prediction request using the PII.

The client DSP can use the POS score to filter the advertisement requests it receives in order to increase the effectiveness of an advertising campaign by ensuring the advertisement is preferentially directed to parties more likely to be interested in the advertisement. For example, the client DSP may elect to only serve an advertisement in response to a prediction request having a POS score in a top decile of POS scores. According to this embodiment, the client DSP does not serve an advertisement in response to a prediction request having a POS score not in the top decile of POS scores. Alternatively, or additionally, the client DSP may reject prediction requests with a POS score below a predetermined POS score threshold.

The client DSP can then use the POS score to target advertisements based on client preferences. The client DSP can use the POS scores in whatever way it chooses to increase one or more of efficiency of an advertising campaign that the client DSP is running and effectiveness of the advertising campaign.

The performance optimization system provides a set of population groups usable to evaluate the performance of the service against a fixed baseline. The prediction server randomly labels a predetermined fraction of prediction requests as control prediction requests belonging to a control group. For example, the prediction server randomly labels 1% of prediction requests as control prediction requests belonging to the control group. The prediction server logs in the prediction request log a control prediction request belonging to the control group. Preferably, but not necessarily, the prediction server logs in the prediction request log each of the control prediction requests. The prediction server logs in the prediction request log a remaining prediction request as a treatment prediction request belonging to a treatment group. Preferably, but not necessarily, the prediction server logs in the prediction request log each of the remaining prediction requests as treatment prediction requests belonging to the treatment group.

The prediction server assigns a non-optimized POS score to the control group. The non-optimized POS score comprises one or more of a random POS score, a fixed POS score, and a POS score that the prediction server chooses in any other way to represent not applying the output from the model scorer. The prediction server assigns the output of the model scorer to the targeted group. The control group serves as a baseline against which to measure the performance of the treatment group. The client DSP can compare the performance of the treatment group compared to the control group, using whatever metric it chooses. If the treatment group shows a statistically significant improvement in prediction accuracy compared to the control group, then the performance optimization system attributes this improvement to the performance optimization system.

The performance optimization system also comprises an analytics interface that can be used to do one or more of expose learnings of the predictive model and enable the client DSP to monitor the performance of the service. For example, the analytics interface is configured to provide analytic information describing an attribute of a desired audience for the brand advertising campaign. For example, the analytics interface identifies the desired audience's attributes for the brand advertising campaign, enabling the client DSP to appropriately target the campaign. Alternatively, or additionally, the analytics interface can provide performance analytics on the different advertisement media (e.g. the different advertisement types like full screen, banner, video, and the like).

Embodiments of the invention provide an automated system to allow a client DSP to optimize in real-time, a brand advertising campaign being run by the client DSP on client systems. The client DSP sends a prediction request in response to the stream of advertisement requests it is receiving, and the invention will provide, in real-time, a POS score that can be used by the client DSP to target content.

The client DSP receives advertisement requests from a provider such as an SSP or directly from a publisher. The client DSP will then determine which of these advertisement requests it will respond to with an advertisement. The client DSP needs a decision-making process to do this. This can be done manually with a human creating a set of rules to select the best advertisement requests. It can be done using a machine learning system, learning which of the advertisement requests are likely to be the best. The invention provides a service where the client DSP queries the invention in real-time and embodiments of the invention determine a predictive POS score that the client DSP uses to decide whether to respond to a particular advertisement request.

FIG. 1 is a drawing of a performance optimization system (POS) 100 configured to build a predictive model to estimate a customer engagement metric. The performance optimization system 100 uses the predictive model to generate a POS score, the POS score configured to estimate awareness of an end user receiving an advertisement request of a brand to be advertised in the advertisement request.

The performance optimization system 100 comprises a POS data platform 102 configured to store data usable to determine the POS score, a machine learning platform 105 configured to use machine learning to determine the POS score, the machine learning platform 105 operably connected to the POS data platform 102, a prediction server 130 operably connected to the machine learning platform 105, the prediction server 130 comprising a server configured to receive a prediction request from a client DSP (not shown in FIG. 1; item 205 in FIG. 2), and a prediction request log 140 operably connected to the prediction server 130. Preferably, but not necessarily, the prediction server 130 is further configured to send the prediction request to the machine learning platform 105. Preferably, but not necessarily, the prediction server 130 is further configured to receive a scored prediction request from the machine learning platform 105. Preferably, but not necessarily, the prediction server 130 is further configured to log the scored prediction request. The prediction request log 140 is configured to log the scored prediction request.

Preferably, but not necessarily, the machine learning platform 105 comprises one or more of a model builder 143 configured to build a predictive model usable to determine the POS score and a model scorer 145 operably connected to the model builder 143, the model scorer 145 configured to receive the predictive model from the model builder 143, the model scorer 145 further configured to determine the POS score using the predictive model. Most preferably, but not necessarily, the machine learning platform 105 comprises both the model builder 143 and the model scorer 145. Preferably, but not necessarily, the POS data platform 102 comprises one or more of a profile store 150 configured to comprise a plurality of profiles of end users, and a model store 160 configured to store predictive models that the model builder 143 builds. Most preferably, but not necessarily, the POS data platform 102 comprises both the profile store 150 and the model store 160. The POS data platform 102 comprises a profile store 150 comprising a plurality of profiles of end users, and a model store 160, the model store 160 configured to store predictive models that the model builder 143 builds. The prediction server 130 is further configured to log a scored prediction request in the prediction request log 140. Preferably, but not necessarily, the prediction server 130 is configured to log all scored prediction requests in the prediction request log 140. The profile store 150 comprises predictive end user data usable by the model builder 143 to build a predictive model. The predictive end user data comprises one or more of behavioral end user data, demographic end user data, and other end user data. The other end user data comprises one or more of end user age, end user income, end user place of residence, and the like.

The prediction request comprises a request for a POS score from a client DSP (not shown in FIG. 1) to the prediction server 130. The prediction request comprises prediction request data. The prediction request data comprises end user data regarding the end user from which the advertisement request originated. For example, the end user data comprises one or more of end user data, end user device data regarding an end user device controlled by the end user, an end user location, and other end user data. For example, the end user data comprises demographic end user data. For example, the end user device data comprises one or more of a device make, a device model number, a device operating system, and another end user device datum.

The POS score comprises one or more of a brand awareness score, a purchase intent score, a brand consideration score, and any other metric configured to estimate awareness of an end user of an advertised brand. The prediction server 130 determines the POS score using the prediction request data received in the prediction request. Alternatively, or additionally, the prediction request comprises a standard advertisement request that the performance optimization system 100 receives directly from an SSP (not shown in FIG. 1). After the prediction server 130 determines the POS score, the prediction server 130 adds the POS score to the prediction request, creating a scored prediction request, and then the prediction server 130 sends the scored prediction request to the client DSP (not shown in FIG. 1).

Although not limited to advertising, the performance optimization system 100 is preferably applied in any field where survey results are used for assessing effectiveness of an action taken by a company or institution, wherein the action taken is intended to do one or more of inform behavior and alter behavior. For example, the performance optimization system 100 is particularly well suited to determine effectiveness of a public information campaign by a government. The performance optimization system 100 is also particularly well suited to perform for companies one or more of new product notifications and functionality notifications to one or more of current company subscribers and company product owners. Additionally, the performance optimization system 100 is particularly well suited to transmit security advisory messages from a bank to existing bank customers.

FIG. 2 is a drawing of an environment 200 in which the performance optimization system 100 operates. The environment 200 comprises a customer engagement platform 201. The customer engagement platform 201 comprises the performance optimization system 100. The performance optimization system 100 again comprises the model builder 143, the model scorer 145, the prediction server 130, the prediction request log 140, and the profile store 150.

The prediction server 130 scores a prediction request to estimate whether the end user 203 receiving the advertisement is likely to be influenced by exposure to the brand advertisement. Preferably, but not necessarily, the prediction server 130 scores each prediction request to estimate whether the end user 203 receiving the advertisement is likely to be influenced by exposure to the brand advertisement. For example, the environment 200 comprise a client DSP 205 operably connected to the performance optimization system 100. If the client DSP 205 has a requirement to achieve a specified number of advertisement views over a specific time, the prediction server 130 scores a prediction request against a generic predictive model and returns a resulting POS score to the client DSP 205. Preferably, but not necessarily, the prediction server 130 scores each prediction request against the generic predictive model and returns each resulting POS score to the client DSP 205. Using the POS score, the client DSP 205 then serves the advertisement to a best advertisement prospect, that is, to an end user 203 that the POS system 100 estimates is the end user 203 that is most likely to increase a customer engagement metric. Preferably, but not necessarily, the client DSP 205 serves the advertisements to the best advertisement prospect in real time. Optionally, the environment 200 further comprises an analytics end user 206, the analytics end user 206 comprising an end user of data collected by the performance optimization system 100, the analytics end user 206 operably connected to the performance optimization system 100.

The end user personal data does not necessarily include personally identifiable information (PII). In some regions of the world, the end user personal data cannot comprise PII without consent of the end user 203. As mentioned above, PII comprises one or more of an end user identifier, an end user location, an end user Internet Protocol (IP) address, an end user telephone number, an end user email address, an end user name, an end user social media handle, and other end user-specific end user data. For example, the end user location comprises an exact end user location. For example, the end user location comprises an end user location that is more precise than a city. The prediction request can also include one or more of details of an application where the prediction request originated, details of a webpage where the prediction request originated, a format of the advertisement, a size of the advertisement spot, and other prediction request information. For example, the advertisement format comprises one or more of Hyper Text Markup Language (HTML), Joint Photographic Experts Group (JPEG), and another advertisement format. The model scorer 145 can use this information to determine a POS score. Alternatively, or additionally, the model scorer 145 can process the raw POS score by means of a threshold, learned or configured, to transform the POS score into a binary value, instructing the client DSP to reject or accept the advertisement request. The prediction server 130 receives the prediction request from the client DSP 205.

The model scorer 145 determines the POS score using the predictive model provided by the model builder 143. Preferably, but not necessarily, the model builder 143 builds the predictive model using customer engagement data comprising survey responses. Most preferably, but not necessarily, the model builder 143 builds the predictive model using all the customer engagement data. The profile store 150 contains one or more of end user profiles and customer engagement survey responses from past end user interactions with the advertisement. Preferably, but not necessarily, the profile store 150 comprises both the end user profiles and the customer engagement survey responses. The model builder 143 uses the profile store to build an effective predictive model usable to determine the POS score for any end user. The prediction server 130 adds the POS score to the prediction request, creating a scored prediction request, and then the prediction server 130 sends the prediction request to the client DSP 205.

Advantageously, the model scorer 145 can determine a customer engagement metric based on the predictive model even for an end user having no survey end user data. That is, the predictive model can be used to extrapolate the obtained survey results to the remainder of the population who were not surveyed. For example, the model builder 143 can determine that presence of certain features in the profile end user data is associated with an increased likelihood of an end user 203 responding positively to the survey question. The presence, or otherwise, of these features in the profile end user data of an unsurveyed end user enables the model scorer 145 to estimate a likelihood of any individual end user to respond positively to the survey question.

The advertisement server 265 then removes from the retrieved end user profiles personally identifiable end user data. If desired, the advertisement server 265 is further configured to remove from the retrieved end user profiles end user data. PII comprises customer engagement data that can personally identify the end user 203, such as one or more of an end user identifier, an end user location, an end user Internet Protocol (IP) address, an end user telephone number, an end user email address, an end user name, an end user social media handle, and other end user-specific end user data. The resulting dataset contains a set of independent variables that has been obtained with whatever consent local legislation requires, but no longer contains PII. The dataset also contains a dependent variable, which is the survey response, which also has been obtained with whatever consent local legislation requires. The preferred embodiment will take only recent data from the last 12 months, although any period is possible. Using this data set, the model builder 143 can train the predictive model with any standard supervised learning technique. The preferred embodiment uses XgBoost, CatBoost, or other gradient-boosted techniques. However, the model builder 143 could also use other techniques, including neural networks, deep learning, logistic regression, and the like. The model scorer 145 scores the prediction requests. Preferably, but not necessarily, the prediction requests received from the client DSP 205 contain none of personally identifiable end user data, an end user identifier, and an IP address, and can thus be used to target advertisement requests with no consent required from the end user 203, wherever in the world the campaign is running. According to embodiments of the invention, end user data can be processed to make a predictive model that does not rely on end user data, and hence the system can provide a POS score for anyone in any country, without requiring consent in those jurisdictions requiring it.

The prediction server 130 logs a scored prediction request in the prediction request log 140. Preferably, but not necessarily, the prediction server 130 logs all scored prediction requests in the prediction request log 140. Preferably, but not necessarily, the prediction request log 140 structures the data in a form that is easy to query, for example as a set of SQL tables. The analytics end user 206 constructs and sends a query to the prediction request log 140. For example, the analytics end user 206 compares demographics of persons having high POS scores with persons having lower POS scores. For example, the client DSP 205 comprises the analytics end user 206. By querying the prediction request log 140, the analytics end user 206 requests from the prediction request log 140 a mean POS score for prediction requests with the attribute, city=New York. For example, the analytics end user requests from the prediction request log 140 a mean POS score for iPhone users. The analytics end user 206 can use the mean POS score to do one or more of better understand an advertising audience and manually target an advertising campaign. The performance optimization system 100 can provide analytics data to the analytics end user 206 using one or more of the scored prediction request and the end user profiles stored in the profile store 150.

The prediction server 130 also maintains a control group usable by the client DSP 205 to measure POS score performance. The performance optimization system 100 provides a set of population groups usable to evaluate the performance of the service against a fixed baseline. The prediction server 130 randomly labels a predetermined fraction of prediction requests as belonging to the control group. The remaining requests all receive a POS score from the model scorer 145 and will be called the treatment group. For example, the prediction server 130 randomly labels 1% of prediction requests as control prediction requests belonging to the control group. The prediction server 130 logs in the prediction request log 140 a control prediction request belonging to the control group. Preferably, but not necessarily, the prediction server 130 logs in the prediction request log 140 each of the control prediction requests. The prediction server 130 logs in the prediction request log 140 a remaining prediction request as a treatment prediction request belonging to a treatment group. Preferably, but not necessarily, the prediction server 130 logs in the prediction request log 140 each of the remaining prediction requests as treatment prediction requests belonging to the treatment group.

The prediction server 130 assigns a non-optimized POS score to the control group. The non-optimized POS score comprises a POS score that the model scorer 145 does not generate. The non-optimized POS score comprises a baseline POS score against which POS scores generated by the model scorer 145 can be compared. The non-optimized POS score is one or more of a random POS score, a fixed POS score and a POS score that the prediction server 130 chooses in any way without applying output from the model scorer 145. The random POS score comprises a POS score that the prediction server 130 randomly selects from a range of all possible POS scores. In the preferred embodiment, the random POS score is a random number drawn from a distribution identical to the POS score distribution. The prediction server 130 assigns the output of the model scorer to the treatment group. The control group serves as a baseline against which to measure the performance of the treatment group. The client DSP 205 can compare the performance of the treatment group to the control group, using whatever metric it chooses. If the prediction requests in the treatment group perform better to a statistically significant level than the prediction requests in the control group, then the performance optimization system 100 attributes this improvement to itself.

The customer engagement platform 201 further comprises an end user system (EUS) 202 configured to run an advertising campaign. The environment 200 further comprises an end user 203. The end user system 202 is also operably connected to the performance optimization system 100. The environment 200 further comprises a client DSP 205, the client DSP 205 operably connected to the prediction server 130. The environment 200 further comprises an analytics end user 206, the analytics end user 206 operably connected to the prediction request log 140. For example, the client DSP 205 comprises the analytics end user 206.

The customer engagement platform 201 is configured to do one or more of gather customer engagement data regarding end user awareness of a brand, generate the POS score, and transmit the POS score to the end user 203. The customer engagement platform generates the POS score by building a predictive model. For example, the customer engagement platform 201 gathers the customer engagement data by running an advertising campaign and recording whether an end user 203 engages with the advertising campaign. Preferably, but not necessarily, the customer engagement platform 201 records whether each end user 203 engages with the advertising campaign. Embodiments of the invention comprise a service provided by the customer engagement platform 201 to the client DSP 205, whereby the client DSP 205 will send a prediction request to the performance optimization system 100. The performance optimization system 100 then generates a POS score for the prediction request, the POS score comprising an end user engagement metric predicting engagement of likelihood that the end user 203 that sent the advertisement request will engage with the advertisement associated with the advertisement request. The customer engagement platform 201 then transmits the POS score for the prediction request to the client DSP 205. The customer engagement platform 201 uses the end user data collected to build a predictive model that the customer engagement platform 201 uses to provide these POS scores. The POS score is usable by the client DSP 205 in deciding whether to bid on a particular advertisement request.

As shown, the end user system 202 comprises an end user platform (EUP) 207. The EUP 207 comprises data needed by the end user system 202 to run the advertising campaign. Preferably, but not necessarily, the EUP 207 comprises a survey store 245, the survey store 245 in turn comprising one or more surveys configured to be sent to the end user 203 to generate a survey response usable to measure effectiveness of the advertising campaign. Preferably, but not necessarily, the EUP 207 further comprises an advertisement store 250, the advertisement store 250 in turn comprising one or more advertisements usable in the advertising campaign. Most preferably, but not necessarily, the EUP 207 comprises both the survey store 245 and the advertisement store 250. The EUP 207 is operably connected to an advertiser 252. The advertiser 252 provides for the survey store 245 a survey the advertiser 252 selects from the survey store 245 for a current advertising campaign.

The end user system 202 further comprises a control logic block 255 operably connected to the end user 203, a survey server 260 operably connected to the control logic block 255, the survey server 260 configured to obtain surveys from the survey store 245, the survey server 260 further configured to send the surveys to the end user 203. The control logic block 255 is configured to receive the survey from the survey server 260, the control logic block 255 further configured to send the survey to the end user 203. The customer engagement platform 201 sends the advertisement request with the end user data to the control logic block 255, receives a response from the advertisement server 265, then returns the response of the advertisement server 265 to the selected end user 203. If the advertisement server 265 does not send a response to the customer engagement platform 201 after some fixed period of time, then the customer engagement platform 201 sends no response to the end user 203.

The end user system 202 further comprises an advertisement server 265, the advertisement server 265 configured to serve an advertisement from the advertisement store 250 to the advertiser.

A brand advertising campaign comprises a set of one or more of advertisements provided by the advertiser 252 that the end user system 202 serves to the end user 203. The end user system 202 is further configured to measure effectiveness of a brand advertising campaign by selecting a survey from the survey store 245, submitting the survey to the end user 203, receiving the survey response from the end user 203, attaching the completed survey response to a profile for the end user 203, and logging the response in the profile store 150.

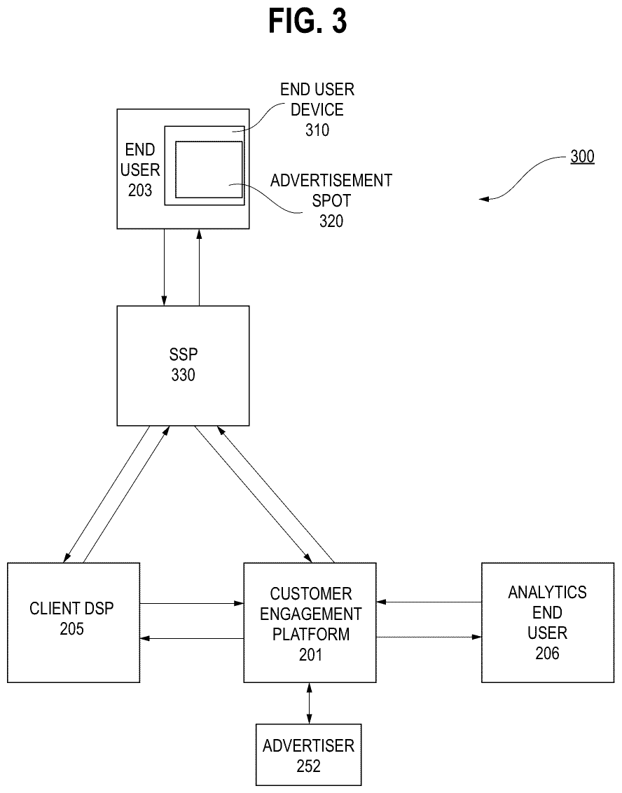

FIG. 3 is a drawing of an online digital advertising campaign environment 300 in which a customer engagement platform 201 provides a performance measurement service for a client DSP 205. The environment 300 again comprises the customer engagement platform 201, the end user 203, the analytics end user 206, and the advertiser 252. The end user 203 comprises an end user device 310 controlled by the end user. The end user device 310 comprises one or more of a computer, a mobile phone, and another end user device. The end user device 310 comprises one or more of a mobile end user device and a non-mobile end user device.

The end user device 310 further comprises an advertisement spot 320 configured to display an advertisement to the end user 203. The advertisement spot 320 comprises one or more of an area reserved for an advertisement within a webpage displayed by the end user device 310 and a portion of an application of the end user device 310 that is reserved for an advertisement. The advertisement spot 320 comprises one or more of a webpage and a mobile application, the advertisement spot 320 comprising a space reserved to display an advertisement. The environment 300 further comprises a supply-side platform (SSP) 330.

The customer engagement platform 201 is again operably connected to both the client DSP 205 and the analytics end user 206. The SSP 330 is operably connected to the client DSP 205, to the customer engagement platform 201, and to the end user 203.

The end user 203, using the end user device 310, views the advertisement spot 320. The advertisement spot 320 then sends an advertisement request for an advertisement to the SSP 330. The SSP 330 then sends the advertisement request to a plurality of DSPs including the customer engagement platform 201.

In an alternative configuration, the client DSP need not send the prediction requests to the customer engagement platform 201. According to these embodiments, the customer engagement platform 201 listens for advertisement requests that are sent by the SSP 330. For example, a system operator configures the customer engagement platform 201 to listen for advertisement requests sent by the SSP 330. When the performance optimization system 100 receives the advertisement request, the performance optimization system 100 creates a prediction request from the advertisement request. The performance optimization system 100, using the prediction server, creates the prediction request 130 by selecting relevant prediction request data from the advertisement request, then copying the relevant prediction request data to the prediction request 130. The performance optimization system 100 scores the prediction request using the model scorer 145. The performance optimization system 100 adds the POS score to the advertisement request, creating a scored prediction request, and sends this scored advertisement request to the client DSP 205. The client DSP 205 then can filter the advertisement request using the POS scores provided by the invention. When the performance optimization system 100 receives the advertisement request, the performance optimization system 100 scores the prediction request using the model scorer 145. The performance optimization system adds the POS score to the prediction, creating a scored prediction request, and sends this scored advertisement request to the client DSP 205. The client DSP 205 then can filter the advertisement request using the POS score provided by the performance optimization system 100.

The customer engagement platform 201 listens for an advertisement request from the end user device 310 of an end user 203. The customer engagement platform 201 receives the advertisement request through one or more of an application programming interface (“API”), a communication port (COM), Common Object Request Broker Architecture (CORBA), Enterprise JavaBeans (EJBs), and the like.

The end user 203 views the advertisement spot 320. As the end user views the advertisement spot 320, the advertisement spot 320 automatically sends the advertisement request to the SSP 330. The SSP 330 sends the advertisement request to the customer engagement platform 201. The SSP 330 then fills the advertisement request using the response from the customer engagement platform 201. The SSP 330 then sends an advertisement (not shown in FIG. 3) to the advertisement spot 320. For example, the advertisement format comprises one or more of Hyper Text Markup Language (HTML), Joint Photographic Exerts Group (JPEG), and another advertisement format. In cases in which the advertisement format comprises HTML, the HTML code renders one or more of the images of the advertisement and the text of the advertisement. Preferably, but not necessarily, the HTML code renders both the images of the advertisement and the text of the advertisement.

Preferably, but not necessarily, an advertiser (not shown in FIG. 3) creates a contract with a client DSP 205 to serve a number of advertisements for a current advertising campaign. The client DSP 205 then displays these advertisements to the end user 203. Preferably, but not necessarily, the client DSP displays the advertisements to a plurality of end users 203. Usually, the advertiser 252 will judge the success of the campaign by some metric measuring the end user's engagement with the advertisements. It is therefore important to the client DSP 205 that the advertiser 252 send the advertisements to the end users most likely to engage with the advertisement. To assist with this, the advertisement request sent from the end user will contain end user data. For example, the end user data comprises one or more of end user data, end user device data regarding the end user device controlled by the end user, an end user location, and other end user data. For example, the end user data comprises demographic end user data. For example, the end user device data comprises one or more of a device make, a device model number, a device operating system, and another end user device datum. The client DSP 205 uses the end user data to select end users most likely to engage with the advertisement if the advertisement is sent to the end user. The client DSP 205 can use the end user data to select the best end users in many ways. For example, the client DSP 205 can use manual targeting where a human decides the best audience for an advertising campaign.

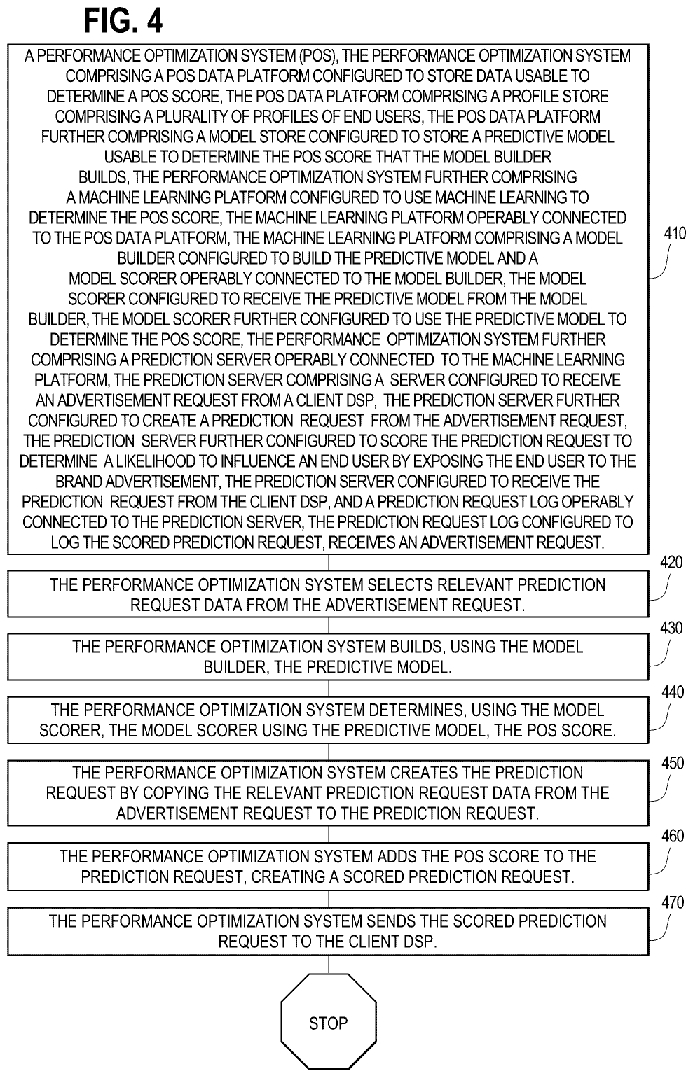

FIG. 4 is a flow chart of a method 400 for optimizing performance using a performance optimization system (POS).

The order of the steps in the method 400 is not constrained to that shown in FIG. 4 or described in the following discussion. Several of the steps could occur in a different order without affecting the final result.

In step 410, a performance optimization system, the performance optimization system comprising a POS data platform configured to store data usable to determine a POS score, the POS data platform comprising a profile store comprising a plurality of profiles of end users, the POS data platform further comprising a model store configured to store a predictive model usable to determine the POS score that the model builder builds, the performance optimization system further comprising a machine learning platform configured to use machine learning to determine the POS score, the machine learning platform operably connected to the POS data platform, the machine learning platform comprising a model builder configured to build the predictive model and a model scorer operably connected to the model builder, the model scorer configured to receive the predictive model from the model builder, the model scorer further configured to use the predictive model to determine the POS score, the performance optimization system further comprising a prediction server operably connected to the machine learning platform, the prediction server comprising a server configured to receive an advertisement request from a client DSP, the prediction server further configured to create a prediction request from the advertisement request, the prediction server further configured to score the prediction request to determine a likelihood to influence an end user by exposing the end user to the brand advertisement, the prediction server configured to receive the prediction request from the client DSP, and a prediction request log operably connected to the prediction server, the prediction request log configured to log the scored prediction request, receives an advertisement request. Block 410 then transfers control to block 420.

In step 420, the performance optimization system selects relevant prediction request data from the advertisement request. Block 420 then transfers control to block 430.

In step 430, the performance optimization system builds, using the model builder, the predictive model. Block 430 then transfers control to block 440.

In step 440, the performance optimization system determines, using the model scorer, the model scorer using the predictive model, the POS score. Block 440 then transfers control to block 450.

In step 450, the performance optimization system creates the prediction request by copying the relevant prediction request data from the advertisement request to the prediction request. Block 450 then transfers control to block 460.

In step 460, the performance optimization system adds the POS score to the prediction request, creating a scored prediction request. Block 460 then transfers control to block 470.

In step 470, the performance optimization system sends the scored prediction request to the client DSP. For example, the method further includes additional steps, performed after the step of receiving the advertisement request directly from the SSP, of: creating, by the performance optimization system, a prediction request from the advertisement request; determining, by the performance optimization system, the POS score; adding, by the performance optimization system, the POS score to the prediction request, creating a scored prediction request; and sending, by the performance optimization system, the scored prediction request to the client DSP. For example, the method further comprises an additional step, performed after the determining step, of:
logging, by the performance optimization system, the scored prediction request in the prediction request log. For example, the determining step comprises sub-steps of: creating a plurality of population groups, one population group comprising a control group comprising a baseline population group against which other population groups' POS scores can be compared, the plurality of population groups usable to determine the POS score for the prediction request; assigning the prediction request to a population group;
and determining the POS score for the prediction request based in part on the prediction request's population group. Block 470 then terminates the process.

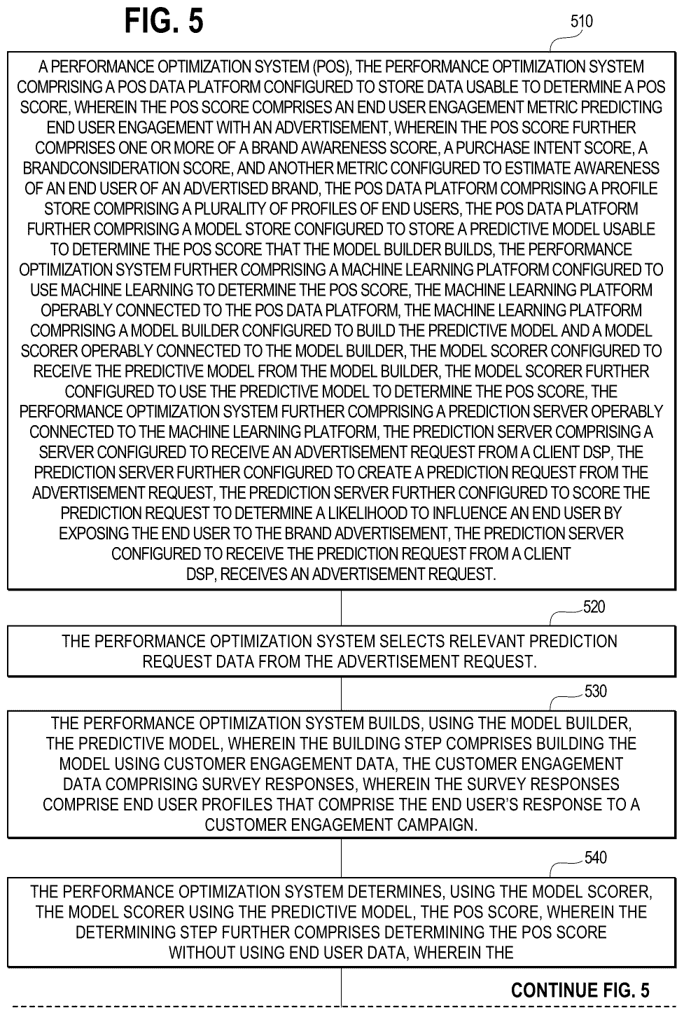

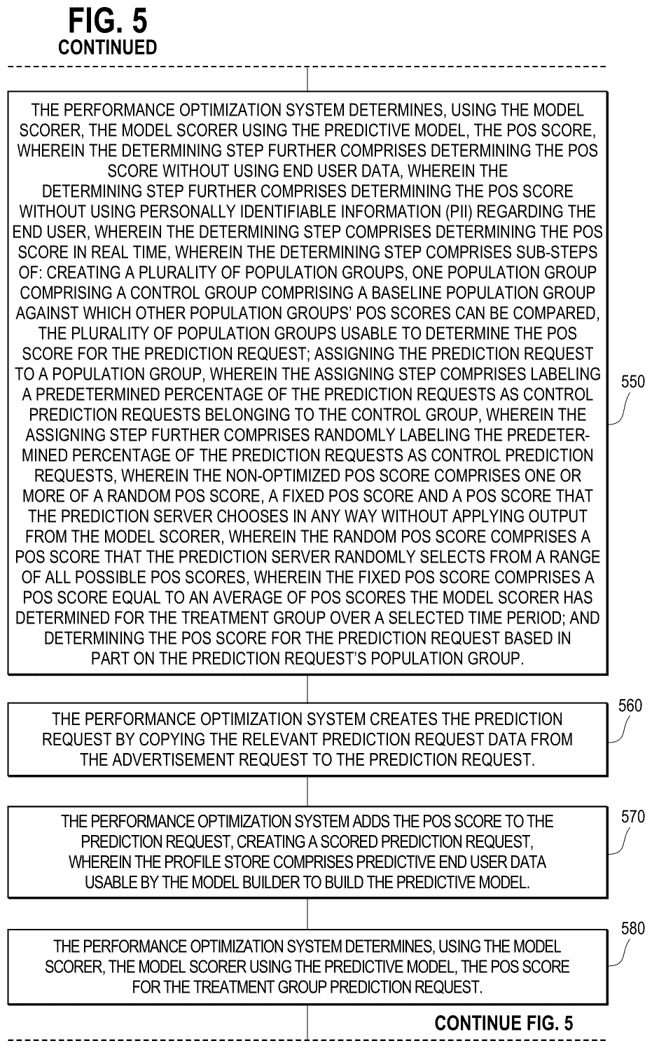

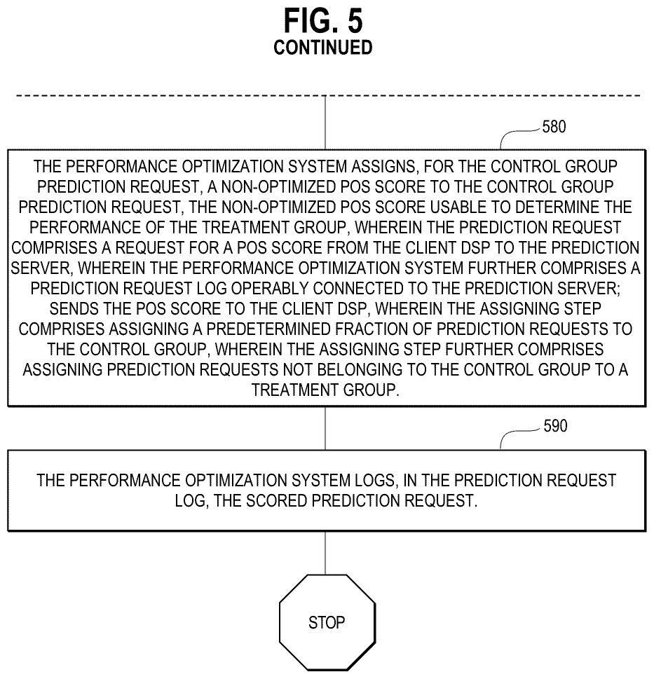

FIG. 5 is a flow chart of a more detailed method 500 for optimizing performance using a performance optimization system.

The order of the steps in the method 500 is not constrained to that shown in FIG. 5 or described in the following discussion. Several of the steps could occur in a different order without affecting the final result.

In step 510, the performance optimization system, the performance optimization system comprising a POS data platform configured to store data usable to determine a POS score, wherein the POS score comprises an end user engagement metric predicting end user engagement with an advertisement, wherein the POS score further comprises one or more of a brand awareness score, a purchase intent score, a brand consideration score, and another metric configured to estimate awareness of an end user of an advertised brand, the POS data platform comprising a profile store comprising a plurality of profiles of end users, the POS data platform further comprising a model store configured to store a predictive model usable to determine the POS score that the model builder builds, the performance optimization system further comprising a machine learning platform configured to use machine learning to determine the POS score, the machine learning platform operably connected to the POS data platform, the machine learning platform comprising a model builder configured to build the predictive model and a model scorer operably connected to the model builder, the model scorer configured to receive the predictive model from the model builder, the model scorer further configured to use the predictive model to determine the POS score, the performance optimization system further comprising a prediction server operably connected to the machine learning platform, the prediction server comprising a server configured to receive an advertisement request from a client DSP, the prediction server further configured to create a prediction request from the advertisement request, the prediction server further configured to score the prediction request to determine a likelihood to influence an end user by exposing the end user to the brand advertisement, the prediction server configured to receive the prediction request from a client DSP, receives an advertisement request. Block 510 then transfers control to block 520.

In step 520, the performance optimization system selects relevant prediction request data from the advertisement request. Block 520 then transfers control to block 530.

In step 530, the performance optimization system builds, using the model builder, the predictive model, wherein the building step comprises building the model using customer engagement data, the customer engagement data comprising survey responses, wherein the survey responses comprise end user profiles that comprise the end user's response to a customer engagement campaign. Block 530 then transfers control to block 540.

In step 540, the performance optimization system determines, using the model scorer, the model scorer using the predictive model, the POS score, wherein the determining step further comprises determining the POS score without using end user data, wherein the determining step further comprises determining the POS score without using personally identifiable information (PII) regarding the end user, wherein the determining step comprises determining the POS score in real time, wherein the determining step comprises sub-steps of: creating a plurality of population groups, one population group comprising a control group comprising a baseline population group against which other population groups' POS scores can be compared, the plurality of population groups usable to determine the POS score for the prediction request; assigning the prediction request to a population group, wherein the assigning step comprises labeling a predetermined percentage of the prediction requests as control prediction requests belonging to the control group, wherein the assigning step further comprises randomly labeling the predetermined percentage of the prediction requests as control prediction requests, wherein the non-optimized POS score comprises one or more of a random POS score, a fixed POS score and a POS score that the prediction server chooses in any way without applying output from the model scorer, wherein the random POS score comprises a POS score that the prediction server randomly selects from a range of all possible POS scores, wherein the fixed POS score comprises a POS score equal to an average of POS scores the model scorer has determined for the treatment group over a selected time period; and determining the POS score for the prediction request based in part on the prediction request's population group. For example, the selected time period comprises a previous 24 hours.

For example, the assigning step comprises randomly labeling the predetermined percentage of the prediction requests as control prediction requests. For example, there is one population group other than the control group. For example, the predetermined percentage comprises 1%. Block 540 then transfers control to block 550.

In step 550, the performance optimization system creates the prediction request by copying the relevant prediction request data from the advertisement request to the prediction request. Block 550 then transfers control to block 560.

In step 560, the performance optimization system adds the POS score to the prediction request, creating a scored prediction request, wherein the profile store comprises predictive end user data usable by the model builder to build the predictive model. Block 560 then transfers control to block 570.

In step 570, the performance optimization system determines, using the model scorer, the model scorer using the predictive model, the POS score for the treatment group prediction request. Block 570 then transfers control to block 580.

In step 580, the performance optimization system assigns, for the control group prediction request, a non-optimized POS score to the control group prediction request, the non-optimized POS score usable to determine the performance of the treatment group, wherein the prediction request comprises a request for a POS score from the client DSP to the prediction server, wherein the performance optimization system further comprises a prediction request log operably connected to the prediction server; sends the POS score to the client DSP, wherein the assigning step comprises assigning a predetermined fraction of prediction requests to the control group, wherein the assigning step further comprises assigning prediction requests not belonging to the control group to a treatment group. Block 580 then transfers control to block 590.

In step 590, the performance optimization system logs, in the prediction request log, the scored prediction request. Block 590 then terminates the process.

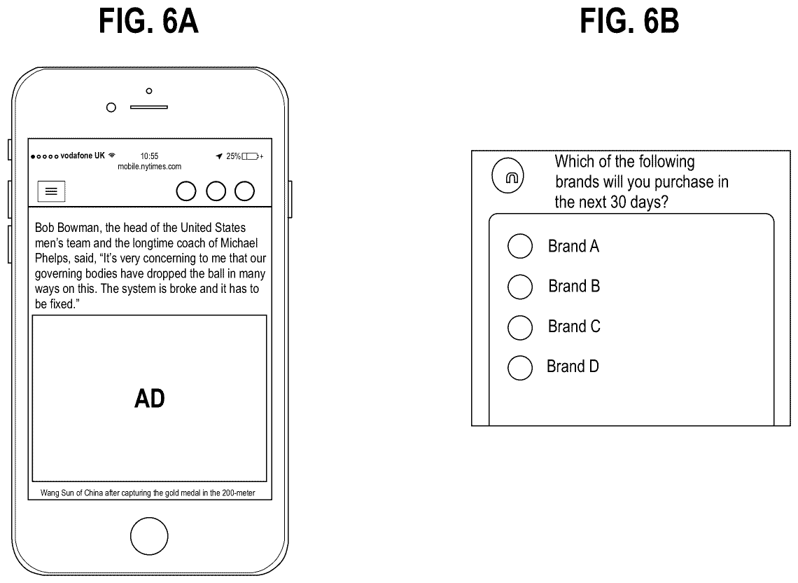

FIG. 6A shows the typical placing of a winning advertisement in the reserved advertisement spot 320 on the end user device 310. This advertising space may be populated by one or more of the winning advertisement and a survey configured to measure the performance of the winning advertisement.

FIG. 6B shows an example of a survey that may be displayed in the reserved advertisement spot 320 in FIG. 6A, including an example survey question sent to the end user asking, “Which of the following brands will you purchase in the next 30 days?” FIG. 6B further depicts four alternative survey answers from which the end user can select its answer. The alternative answers are: Brand A, Brand B, Brand C, and Brand D.

Advantages of embodiments of the invention include that a predictive model is not built for a specific product in a specific advertising campaign, as most prior art systems do, but instead, embodiments of the invention provide a generic predictive model, harvested from a large quantity of historic data, the generic predictive model configured to estimate end user customer engagement for one or more of any product of interest and any end user of interest. There is no requirement that the product of interest be previously seen in order for embodiments of the invention to be able to build the generic predictive model predicting end user customer engagement for that product. Moreover, there is no requirement that the end user of interest be previously seen in order for embodiments of the invention to be able to build the generic predictive model predicting end user customer engagement for that end user.

A further advantage of embodiments of the invention is that the preferred embodiments of the system scores the prediction requests with the POS score in real time using only non-personal end user data comprised in the prediction requests. Unlike many other prior art systems, preferred embodiments of the invention do not require any personal end user data in order to produce optimal results.

A yet other advantage of embodiments of the invention is that by providing the POS score to the client DSP, the client DSP can use a low POS score for an advertisement below the POS score threshold and can abstain from serving the advertisement.

Still another advantage of embodiments of the invention is that the embodiments of the invention are designed so that only a relatively small number of survey responses are needed with the consent of the end user to build a predictive model that can then be used to target all end users, whether those end users provide their consent or not. For example, embodiments of the invention can effectively target advertisements to end users when a number of end users providing consent is as low as ten percent (10%).

Another advantage of embodiments of the invention is that the client DSP can use the POS score to decide whether to reject an advertisement request. For example, if a POS score for an advertisement request is below a POS score threshold, the client DSP rejects the advertisement request. An advertising campaign being run by the DSP thereby increases one or more of its efficiency and its effectiveness.

A yet further advantage of embodiments of the invention is providing an automated system to allow the client DSP to optimize in real-time a brand advertising campaign being run by the client DSP on a client system. Another advantage of embodiments of the invention is that in response to stream of advertisement requests received from the client DSP, the invention can provide, in real-time, a POS score, that can be used by the client DSP to target content.

Another advantage is that the performance optimization system is not limited to advertising and can be used in any field where survey results are used for assessing effectiveness of an action taken by a company or institution, wherein the action taken is intended to do one or more of inform behavior and alter behavior. For example, the performance optimization system is particularly well suited to determine effectiveness of a public information campaign by a government. The performance optimization system is similarly well suited to perform for companies one or more of new product notifications and functionality notifications to one or more of current company subscribers and company product owners. Moreover, the performance optimization system is particularly well suited to transmit security advisory messages from a bank to existing bank customers.

A still further advantage of embodiments of the invention is that customer engagement data can be processed to make predictive models that do not rely on personal end user data, and hence the system can provide a POS score for anyone in any country, without requiring consent in those jurisdictions requiring it. A yet other advantage of embodiments of the invention is that the system can operate without using personally identifiable information (PII) regarding the end user. Still a further advantage of embodiments of the invention is that the system can operate without requiring PII. A still further advantage of embodiments of the invention is that this feature facilitates performing targeted advertising in geographies with the highest end user privacy standards.

A yet other advantage of embodiments of the invention is that the system can operate without requiring personal end user data. A still further advantage of embodiments of the invention is that this feature facilitates performing targeted advertising in geographies with the highest end user privacy standards.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

1. A performance optimization system (POS) comprising:
a POS data platform configured to store data usable to determine the POS score;
a machine learning platform configured to use machine learning to determine the POS score, the machine learning platform operably connected to the POS data platform;
a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement;
and a prediction request log operably connected to the prediction server, the prediction request log configured to log the scored prediction request.

2. The performance optimization system of claim 1, wherein the prediction server creates the prediction request by selecting relevant prediction request data from the advertisement request, the prediction server then copying the relevant prediction request data to the prediction request.

3. The performance optimization system of claim 2, wherein the prediction request data comprises end user data.

4. The performance optimization system of claim 3, wherein the end user data comprises one or more of end user personal data, end user device data, contextual data, advertisement spot data, website data, mobile app data, network data, and privacy data.

5. The performance optimization system of claim 2, wherein the prediction server sends the prediction request to the machine learning platform.

6. The performance optimization system of claim 1, wherein the machine learning platform comprises one or more of a model builder configured to build a predictive model usable to determine the POS score and a model scorer operably connected to the model builder, the model scorer configured to receive the predictive model from the model builder, the model scorer further configured to use the predictive model to determine the POS score.

7. The performance optimization system of claim 6, the machine learning platform comprising both the model builder and the model scorer.

8. The performance optimization system of claim 7, wherein the prediction server adds the POS score to the prediction request, creating a scored prediction request, and sends the scored prediction request to the client DSP.

9. The performance optimization system of claim 8, wherein the prediction server is further configured to log the scored prediction request in the prediction request log.

10. The performance optimization system of claim 1, wherein the POS data platform comprises one or more of a profile store comprising a plurality of profiles of end users and a model store configured to store predictive models that the model builder builds.

11. The performance optimization system of claim 10, the POS data platform comprising both the profile store and the model store.

12. The performance optimization system of claim 1, wherein the POS score comprises an end user engagement metric predicting end user engagement with an advertisement.

13. The performance optimization system of claim 12, wherein the POS score comprises one or more of a brand awareness score, a purchase intent score, a brand consideration score, and another metric configured to estimate awareness of an end user of an advertised brand.

14. The performance optimization system of claim 11, wherein the profile store comprises predictive end user data usable by the model builder to build the predictive model.

15. The performance optimization system of claim 1, wherein the performance optimization system is operably connected to the client DSP.

16. The performance optimization system of claim 15, wherein the client DSP comprises an entity doing one or more of running an advertising campaign directly as an advertiser and running the advertising campaign on behalf of an advertiser.

17. The performance optimization system of claim 1, wherein the performance optimization system is operably connected to an analytics end user, the analytics end user comprising an end user of data collected by the performance optimization system.

18. The performance optimization of claim 17, wherein the performance optimization system provides analytics data to the analytics end user using one or more of the scored prediction request and the end user profiles stored in the profile store.

19. The performance optimization system of claim 17, wherein the client DSP comprises the analytics end user.

20. The performance optimization system of claim 1, wherein the model scorer scores the prediction request without using end user data.

21. The performance optimization system of claim 20, wherein the model scorer scores the prediction request without requiring the end user data.

22. The performance optimization system of claim 1, wherein the model scorer scores the prediction request without using personally identifiable information (PII) regarding the end user.

23. The performance optimization system of claim 22, wherein the model scorer scores the prediction request without requiring the PII.

24. The performance optimization system of claim 1, wherein the prediction request comprises a request for a POS score from the client DSP to the prediction server.

25. The performance optimization system of claim 1, wherein the prediction server receives the advertisement request directly from an SSP.

26. The performance optimization system of claim 25, wherein the prediction server determines the POS score, the prediction server adds the POS score to the prediction request, creating a scored prediction request, and then the prediction server sends the prediction request to the client DSP.

27. The performance optimization system of claim 6, wherein the model builder builds the model using customer engagement data.

28. The performance optimization system of claim 27, wherein the customer engagement data comprises survey responses.

29. The performance optimization system of claim 1, wherein the performance optimization system determines the POS score in real time.

30. A performance optimization system (POS) comprising:
a POS data platform configured to store data usable to determine the POS score;
a machine learning platform configured to use machine learning to determine the POS score, the machine learning platform operably connected to the POS data platform;
a prediction server operably connected to the machine learning platform, the prediction server comprising a server configured to receive an advertisement request from a client demand-side platform (DSP), the prediction server further configured to create a prediction request from the advertisement request by selecting relevant prediction request data from the advertisement request, the prediction request data comprising end user data, the prediction server then copying the relevant prediction request data to the prediction request, the prediction server sending the prediction request to the machine learning platform,
the prediction server further configured to score the prediction request to determine a likelihood to influence an end user by exposing the end user to the brand advertisement;
and a prediction request log operably connected to the prediction server,
wherein the machine learning platform comprises a model builder configured to build a predictive model usable to determine the POS score, the machine learning platform further comprising a model scorer operably connected to the model builder, the model scorer configured to receive the predictive model from the model builder, the model scorer further configured to use the predictive model to determine the POS score, wherein the POS score comprises an end user engagement metric predicting end user engagement with an advertisement, wherein the POS score further comprises one or more of a brand awareness score, a purchase intent score, a brand consideration score, and another metric configured to estimate awareness of an end user of an advertised brand, wherein the prediction server is further configured to add the POS score to the prediction request, creating a scored prediction request, wherein the prediction server is further configured to send the scored prediction request to the client DSP, wherein the prediction server is further configured to log the scored prediction request in the prediction request log, wherein the prediction request log is configured to log the scored prediction request, wherein the POS data platform comprises a profile store comprising a plurality of profiles of end users, the POS data platform further comprising a model store configured to store predictive models that the model builder builds, wherein the profile store comprises predictive end user data usable by the model builder to build the predictive model, wherein the performance optimization system is operably connected to a client demand-side platform (DSP), wherein the client DSP comprises an entity configured to do one or more of run an advertising campaign directly as an advertiser and run the advertising campaign on behalf of an advertiser, wherein the model scorer scores the prediction request without using the end user data, wherein the model scorer scores the prediction request without using personally identifiable information (PII) regarding the end user, wherein the prediction request comprises a request for a POS score from a client DSP to the prediction server, wherein the model builder builds the model using customer engagement data.

31. The performance optimization system of claim 30, wherein the customer engagement data comprises survey responses.

32. A customer engagement platform configured to gather customer engagement data regarding awareness by an end user of a brand, the customer engagement platform gathering customer engagement data by running an advertising campaign and recording whether the end user engages with the advertising campaign, the customer engagement platform comprising a performance optimization system (POS) and an end user system configured to run an advertising campaign, the end user system operably connected to the performance optimization system, the performance optimization system comprising:
a POS data platform configured to store data usable to determine the POS score;
a machine learning platform configured to use machine learning to determine the POS score, the machine learning platform operably connected to the POS data platform;
a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement;
and a prediction request log operably connected to the prediction server, the prediction request log configured to log the scored prediction request;
and the end user system comprising:
a control logic block operably connected to the end user, the control logic block configured to send a survey to the end user, the control logic block further configured to receive a survey response from the end user, the control logic bock further configured to send the survey response to the survey server, the control logic block further configured to log the survey response;
a survey server operably connected to the control logic block, the survey server configured to obtain the survey from the survey store, the survey server further configured to send the survey to the control logic block, the survey server further configured to receive a survey response from the end user;
an advertisement server operably connected to the control logic block, the advertisement server also operably connected to the survey server, the advertisement server configured to serve an advertisement to the end user; and an end user platform (EUP) comprising data needed by the end user system to run the advertising campaign, the EUP further comprising a survey store, the survey store comprising a survey configured to be sent to the end user to generate a survey response usable to measure effectiveness of the advertising campaign, the survey store logging the survey response that the control logic block logs, the EUP further comprising an advertisement store, the advertisement store comprising an advertisement usable in the advertising campaign.

33. The customer engagement platform of claim 32, wherein the advertisement server is further configured to remove from a retrieved end user profile personally identifiable end user data.

34. A method for optimizing performance, comprising:
receiving, by a performance optimization system (POS) comprising a POS data platform configured to store data usable to determine a POS score, the POS data platform comprising a profile store comprising a plurality of profiles of end users, the POS data platform further comprising a model store configured to store a predictive model usable to determine the POS score that the model builder builds, the performance optimization system further comprising a machine learning platform configured to use machine learning to determine the POS score, the machine learning platform operably connected to the POS data platform, the machine learning platform comprising a model builder configured to build the predictive model and a model scorer operably connected to the model builder, the model scorer configured to receive the predictive model from the model builder, the model scorer further configured to use the predictive model to determine the POS score, the performance optimization system further comprising a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement, the prediction server configured to receive the prediction request from the client DSP, and a prediction request log operably connected to the prediction server, the prediction request log configured to log the scored prediction request, an advertisement request;
selecting, by the performance optimization system, relevant prediction request data from the advertisement request;
building, by the performance optimization system, using the model builder, the predictive model;
determining, by the performance optimization system, using the model scorer, the model scorer using the predictive model, the POS score;
creating, by the performance optimization system, the prediction request by copying the relevant prediction request data from the advertisement request to the prediction request;
adding, by the performance optimization system, the POS score to the prediction request, creating a scored prediction request;
and sending, by the performance optimization system, the POS score to the client DSP.

35. The method of claim 34, wherein the prediction request data comprises end user data.

36. The method of claim 35, wherein the end user data comprises one or more of end user personal data, end user device data, contextual data, advertisement spot data, website data, mobile app data, network data, and privacy data.

37. The method of claim 36, wherein the POS score comprises an end user engagement metric predicting end user engagement with an advertisement.

38. The method of claim 37, wherein the POS score comprises one or more of a brand awareness score, a purchase intent score, a brand consideration score, and another metric configured to estimate awareness of an end user of an advertised brand.

39. The method of claim 34, wherein the profile store comprises predictive end user data usable by the model builder to build the predictive model.

40. The method of claim 34, wherein the determining step comprises determining the POS score without using end user data.

41. The method of claim 40, wherein the determining step comprises determining the POS score without requiring the end user data.

42. The method of claim 34, wherein the determining step comprises determining the POS score without using personally identifiable information (PII) regarding the end user.

43. The method of claim 42, wherein the determining step comprises determining the POS score without requiring the PII.

44. The method of claim 34, wherein the determining step comprises determining the POS score in real time.

45. The method of claim 34, wherein the prediction request comprises a request for a POS score from a client DSP to the prediction server.

46. The method of claim 34, wherein the receiving step comprises receiving the advertisement request directly from a supply-side platform (SSP).

47. The method of claim 46, wherein the method further includes additional steps, performed after the step of receiving the advertisement request directly from the SSP, of:
creating, by the performance optimization system, a prediction request from the advertisement request;
determining, by the performance optimization system, the POS score;
adding, by the performance optimization system, the POS score to the prediction request, creating a scored prediction request; and
sending, by the performance optimization system, the scored prediction request to the client DSP.

48. The method of claim 34, wherein the building step comprises building the model using customer engagement data.

49. The method of claim 48, wherein the customer engagement data comprises survey responses.

50. The method of claim 49, wherein the survey responses comprise end user profiles that comprise the end user's response to a customer engagement campaign.

51. The method of claim 34, wherein the method further comprises an additional step, performed after the determining step, of:
logging, by the performance optimization system, the scored prediction request in the prediction request log.

52. The method of claim 34, wherein the determining step comprises sub-steps of:
creating a plurality of population groups, one population group comprising a control group comprising a baseline population group against which other population groups' POS scores can be compared, the plurality of population groups usable to determine the POS score for the prediction request;
assigning the prediction request to a population group; and
determining the POS score for the prediction request based in part on the prediction request's population group.

53. The method of claim 52, wherein there is one population group other than the control group.

54. The method of claim 52, wherein the assigning step comprises assigning a predetermined fraction of prediction requests to the control group.

55. The method of claim 54, wherein the assigning step comprises assigning prediction requests not belonging to the control group to a treatment group.

56. The method of claim 52, wherein the determining step comprises determining, by the performance optimization system, using the model scorer, the model scorer using the predictive model, the POS score for the treatment group prediction request, and wherein the determining step further comprises assigning, by the performance optimization system, for the control group prediction request, a non-optimized POS score to the control group prediction request, the non-optimized POS score usable to determine the performance of the treatment group.

57. The method of claim 52, wherein the assigning step comprises labeling a predetermined percentage of the prediction requests as control prediction requests belonging to the control group.

58. The method of claim 57, wherein the assigning step comprises randomly labeling the predetermined percentage of the prediction requests as control prediction requests.

59. The method of claim 57, wherein the predetermined percentage comprises 1 percent.

60. The method of claim 57, wherein the non-optimized POS score comprises one or more of a random POS score, a fixed POS score and a POS score that the prediction server chooses in any way without applying output from the model scorer.

61. The method of claim 60, wherein the random POS score comprises a POS score that the prediction server randomly selects from a range of all possible POS scores.

62. The method of claim 60, wherein the random POS score comprises a random number drawn from a distribution identical to a distribution of POS scores for the treatment group.

63. The method of claim 60, wherein the fixed POS score comprises a POS score equal to an average of POS scores that the model scorer has determined for the treatment group over a selected time period.

64. The method of claim 63, wherein the time period comprises a previous 24 hours.

65. A method for optimizing performance, comprising:
receiving, by a performance optimization system (POS) comprising a POS data platform configured to store data usable to determine a POS score, wherein the POS score comprises an end user engagement metric predicting end user engagement with an advertisement, wherein the POS score further comprises one or more of a brand awareness score, a purchase intent score, a brand consideration score, and another metric configured to estimate awareness of an end user of an advertised brand, the POS data platform comprising a profile store comprising a plurality of profiles of end users, the POS data platform further comprising a model store configured to store a predictive model usable to determine the POS score that the model builder builds, the performance optimization system further comprising a machine learning platform configured to use machine learning to determine the POS score, the machine learning platform operably connected to the POS data platform, the machine learning platform comprising a model builder configured to build the predictive model and a model scorer operably connected to the model builder, the model scorer configured to receive the predictive model from the model builder, the model scorer further configured to use the predictive model to determine the POS score, the performance optimization system further comprising a prediction server operably connected to the machine learning platform, the prediction server comprising a server configured to receive an advertisement request from a client demand-side platform (DSP), the prediction server further configured to create a prediction request from the advertisement request, the prediction server further configured to score the prediction request to determine a likelihood to influence an end user by exposing the end user to the brand advertisement, the prediction server configured to receive the prediction request from a client demand-side platform (DSP), an advertisement request;
selecting, by the performance optimization system, relevant prediction request data from the advertisement request, wherein the prediction request data comprises end user data;
building, by the performance optimization system, using the model builder, the predictive model, wherein the building step comprises building the model using customer engagement data, the customer engagement data comprising survey responses, wherein the survey responses comprise end user profiles that comprise the end user's response to a customer engagement campaign;
determining, by the performance optimization system, using the model scorer, the model scorer using the predictive model, the POS score, wherein the determining step further comprises determining the POS score without using end user data, wherein the determining step further comprises determining the POS score without using personally identifiable information (PII) regarding the end user, wherein the determining step comprises determining the POS score in real time, wherein the determining step comprises sub-steps of:
creating a plurality of population groups, one population group comprising a control group comprising a baseline population group against which other population groups' POS scores can be compared, the plurality of population groups usable to determine the POS score for the prediction request;
assigning the prediction request to a population group, wherein the assigning step comprises labeling a predetermined percentage of the prediction requests as control prediction requests belonging to the control group, wherein the assigning step further comprises randomly labeling the predetermined percentage of the prediction requests as control prediction requests, wherein the non-optimized POS score comprises one or more of a random POS score, a fixed POS score and a POS score that the prediction server chooses in any way without applying output from the model scorer, wherein the random POS score comprises a POS score that the prediction server randomly selects from a range of all possible POS scores, wherein the fixed POS score comprises a POS score equal to an average of POS scores the model scorer has determined for the treatment group over a selected time period; and
determining the POS score for the prediction request based in part on the prediction request's population group;
creating, by the performance optimization system, the prediction request by copying the relevant prediction request data from the advertisement request to the prediction request;
adding, by the performance optimization system, the POS score to the prediction request, creating a scored prediction request;
sending, by the performance optimization system, the POS score to the client DSP, wherein the profile store comprises predictive end user data usable by the model builder to build the predictive model;
determining, by the performance optimization system, using the model scorer, the model scorer using the predictive model, the POS score for the treatment group prediction request;
assigning, by the performance optimization system, for the control group prediction request, a non-optimized POS score to the control group prediction request, the non-optimized POS score usable to determine the performance of the treatment group, wherein the prediction request comprises a request for a POS score from the client DSP to the prediction server, wherein the performance optimization system further comprises a prediction request log operably connected to the prediction server, and
logging, by the performance optimization system, in the prediction request log, the scored prediction request, wherein the assigning step comprises assigning a predetermined fraction of prediction requests to the control group, wherein the assigning step further comprises assigning prediction requests not belonging to the control group to a treatment group.

66. The method of claim 65, wherein the receiving step comprises receiving the advertisement request directly from a supply-side platform (SSP).

67. The method of claim 66, wherein the method further includes additional steps, performed after the step of receiving the advertisement request directly from the SSP, of:
creating, by the performance optimization system, a prediction request from the advertisement request;
determining, by the performance optimization system, the POS score;
adding, by the performance optimization system, the POS score to the prediction request creating a scored prediction request;
sending, by the performance optimization system, the scored prediction request to the client DSP.
